(19) United States
(12) Patent Application Publication
(10) Pub. No.: US 2003/0230977 A1
(43) Pub. Date: Dec. 18, 2003

(54) Semiconductor light emitting device with fluoropolymer lens

(76) Inventor: Howard C. Epstein, Los Altos, CA (US)

Correspondence Address: PATENT LAW GROUP LLP, 2635 NORTH FIRST STREET, SUITE 223, SAN JOSE, CA, 95134, US

(21) Appl. No.: 10/170,882

(22) Filed: Jun. 12, 2002

(51) Int. Cl. H01J 1/62

(52) U.S. Cl. 313/512

(57) ABSTRACT

A light emitting device includes a lens and a semiconductor light emitting device chip underlying the lens. The lens may be a fluoropolymer material. In some embodiments, the semiconductor light emitting device chip is capable of emitting light having a peak wavelength ranging from green through blue. The clarity of the fluoropolymer lens is essentially unchanged after 500 hours of exposure to 600 mW of light at 85° C. and 60% relative humidity.

### BACKGROUND

1. Field of Invention

This invention relates to semiconductor light emitting device packages having fluoropolymer lenses.

2. Description of Related Art

Semiconductor light emitting devices such as light emitting diodes (LEDs) are among the most efficient light sources currently available. Currently of particular interest are light emitting devices capable of emitting light in the green through ultraviolet wavelength range. The light emitting from such light emitting devices can be phosphor converted or combined with light of other colors to produce white light. One example of a semiconductor materials system capable of producing such light is group III-V semiconductors, particularly binary, ternary, and quaternary alloys of gallium, aluminum, indium, and nitrogen, also referred to as III-nitride materials.

A light emitting device chip generally includes multiple semiconductor layers formed on a substrate. Appropriate contacts are electrically connected to certain semiconductor layers. The light emitting device chip may be mounted on a submount, then the combination of the light emitting device chip and the submount is packaged.

Though light is generated efficiently within the light emitting device chip, it can be difficult to extract light from the chip and the package. Accordingly, the materials used in packages are selected to have high clarity to prevent light from scattering within the package and to have an index of refraction as closely matched as possible to materials within the package to prevent refraction at the optical interfaces. To prevent total internal refraction at the boundary of the light emitting device chip, the chip is embedded in a material that has an index of refraction that is matched as closely as possible to the high index of refraction materials that are normally within a light emitting device chip. The embedding material may be hard or soft. The components in the optical path, such as the lens, may be selected to match the index of refraction of the embedding material. Such matching of the indices of refraction prevents reflections at the interface between the embedding material and the lens and prevents unwanted changes in the direction of light rays from refraction.

### SUMMARY

In accordance with embodiments of the invention, a light emitting device includes a lens and a semiconductor light emitting device chip underlying the lens. The lens may be a fluoropolymer material. In some embodiments, the semiconductor light emitting device chip is capable of emitting light having a peak wavelength ranging from green through blue. The clarity of the fluoropolymer lens is essentially unchanged after 500 hours of exposure to 600 mW of light at 85° C. and 60% relative humidity.

### BRIEF DESCRIPTION OF THE DRAWINGS

FIG. 1 illustrates a light emitting device package according to an embodiment of the present invention.

FIG. 2 illustrates a light emitting device package according to an alternative embodiment of the present invention.

### DETAILED DESCRIPTION

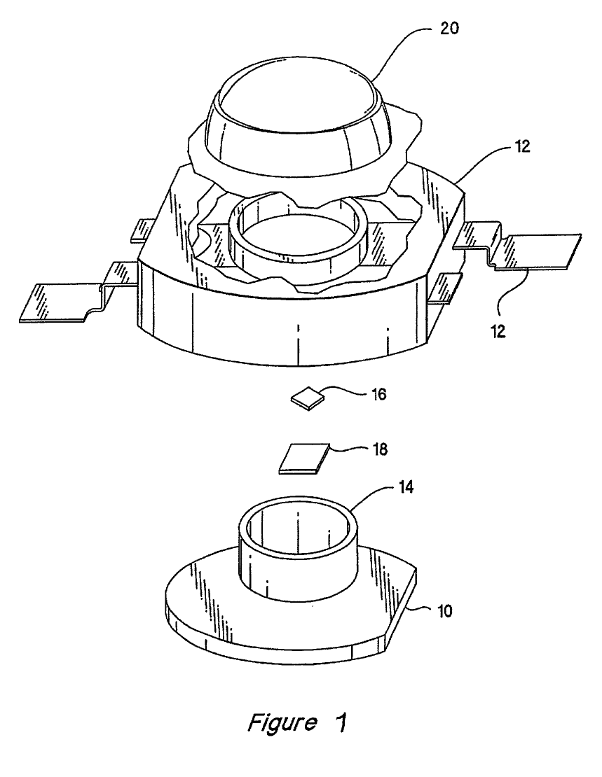

FIG. 1 illustrates an embodiment of a light emitting device package, according to an embodiment of the present invention. Some aspects of the package illustrated in FIG. 1 are described in more detail in U.S. Pat. No. 6,274,924, issued Aug. 14, 2001, titled “Surface Mountable LED Package,” and incorporated herein by reference. A light emitting device chip 16 may emit light with a peak wavelength ranging from infrared to ultraviolet. In one embodiment, light emitting device chip 16 emits light having a peak wavelength ranging from green through near ultraviolet, about 570 nm to about 360 nm. In other embodiments, light emitting device chip 16 emits light having a wavelength in the ultraviolet range (about 200 nm to about 360 nm), for example, about 280 nm. Light emitting device chip 16 typically includes several semiconductor layers, including an n-type region, an active region capable of emitting light, and a p-type region formed over a substrate. The active region is formed between the n-type region and the p-type region. Each of the n-type region, the p-type region, and the active region may be a single layer or may include multiple layers. For example, the n-type and p-type regions may include contact layers and cladding layers and the active region may include quantum wells and barrier layers. Depending on the materials system used to form the semiconductor layers, either the n-type region or the p-type region may be adjacent to the substrate.

Contacts are electrically connected to the n-type region and the p-type region. If the substrate is conducting, one contact may be formed on the surface of the substrate opposite the semiconductor layers, and the other contact may be formed on the surface of the semiconductor layers opposite the substrate. If the substrate is poorly conducting, both contacts may be formed on the same side of the semiconductor layers. When light emitting device chip 16 is included in the package illustrated in FIG. 1, it may be mounted such that light is extracted through the growth substrate, known as a flip chip configuration, or it may be mounted such that light is extracted through the semiconductor layers.

In one embodiment, light emitting device chip 16 is a III-nitride device, meaning the n-type region, the active region, and the p-type region are AlₓIn_{y}Ga_{z}N, where 0≦x≦1, 0≦y≦1, 0≦z≦1, x+y+z=1. In a III-nitride light emitting device chip, the substrate may be, for example, sapphire, SiC, GaN, or any other suitable substrate. The contacts are formed on the same side of the device and are highly reflective, such that the III-nitride light emitting device chip is mounted in a flip chip configuration in the package illustrated in FIG. 1.

Light emitting device chip 16 may be mounted on a submount 18, which may be, for example, silicon. Submount 18 may be electrically conducting or insulating. In the example of a III-nitride light emitting device chip 16, interconnects such as solder may be used to electrically and physically connect the contacts of chip 16 to submount 18. Multiple chips 16 may be mounted on submount 18, or a single chip 16 may include multiple light emitting devices formed monolithically on a single substrate. Submount 18 may include circuitry for various purposes, including for example, circuitry for electrostatic discharge protection or circuitry for individually addressing multiple chips mounted on submount 18. Submount 18 electrically connects chip 16 to lead frame 12.

Chip 16 mounted on submount 18 may be placed in a heat sinking slug 10, which fits into lead frame 12. Slug 10 may include an optional reflector cup 14 for directing light emitted from chip 16 out of the package. Submount 18 and slug 10 are thermally conductive to conduct heat away from chip 16. Slug 10 may be thermally isolated from lead frame 12 and may be attached to an external heat sink (not shown) to prevent the buildup of heat within the package. Suitable thermally conductive materials for slug 10 are, for example, pure materials such as copper, aluminum, and molybdenum. Suitable thermally conductive materials for submount 18 include, for example, aluminum nitride; aluminum oxide; beryllia; alloys; and composites. Reflector cup 14 may be made of a thermally conductive material that has been plated for reflectivity. Suitable materials include, for example, silver, aluminum, and plastics with reflective coatings.

Lead frame 12 may be, for example, a filled plastic material molded around a metal frame that provides an electrical path. The plastic material provides structural integrity to the package and is usually electrically insulating and with low thermal conductivity.

An optical lens 20 is attached over lead frame 12. The space between lens 20 and lead frame 12 may be filled by a hard or soft optically transparent encapsulant with a refractive index selected to maximize the amount of light exiting the package. The optically transparent encapsulant used may depend on the particular chip 16 used in the package. U.S. Pat. No. 6,204,523 names at column 3, lines 32-34 several conventional materials which may be used for lens 20, including “PMMA, glass, polycarbonate, optical nylon, transfer molded epoxy, and cyclic olefin copolymer.”

The device may incorporate a wavelength converting material such as a phosphor, which converts the wavelength of light emitted by the active region of the chip, usually to a longer wavelength. The wavelength converting material may be incorporated into the device by any suitable technique, including, for example, depositing a conformal layer of wavelength converting material over the chip or mixing wavelength converting material with the optically transparent encapsulant. In one embodiment, the wavelength converting material may be selected and incorporated into the device such that light emitted from the active region of the chip mixes with light emitted from the wavelength converting layer to form white light. In another embodiment, the wavelength converting material may be selected and incorporated into the device such that light emitted from the wavelength converting layer is green light.

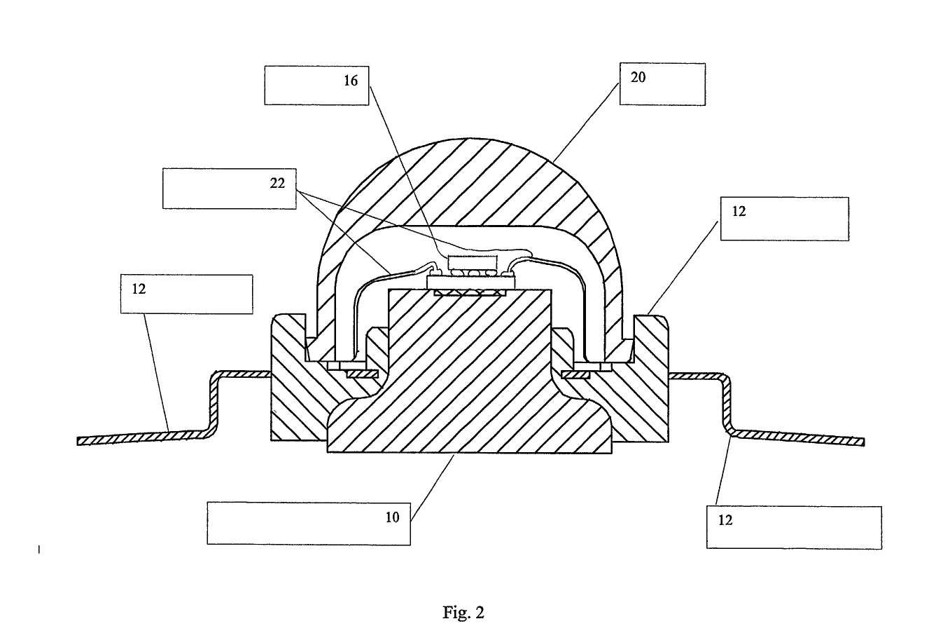

FIG. 2 illustrates an alternative embodiment of a light emitting device package. In the package of FIG. 2, lens 20 is more dome-shaped than the lens of the package illustrated in FIG. 1. In addition, slug 10 of FIG. 2 does not include a reflector cup 14, though the surface of base 10 on which chip 16 sits may be made reflective. FIG. 2 also illustrates bonding wires 22 connected chip 16 to lead frame 12.

Applicant has discovered that some of the most common materials used for lens 20, such as polycarbonate, polysulfone, and epoxy, degrade upon exposure to high intensity light in the green through blue wavelength range, though the same lenses often perform well and do not show the same degradation when exposed to red or amber light. When conventional lens materials are exposed to cyan colored light (about 500 nm) at 85° C. and 85% humidity, white clouds may form in the lenses between about 500 and about 1000 hours. After about 1500 hours, conventional lenses are generally almost completely opaque. The clouds appeared to be microvoids that cause scattering of the light. The microvoids may be caused by light-inducing oxidation, which damages the lens. Moisture enters the lens through the damaged parts, causing local swelling of the lens material, which can ultimately create cracks in the lens material. Once the clouds begin to appear, they cause scattering that traps light within the package. As a result, once the clouds begin to appear, the lens quickly degrades to opaqueness.

In accordance with an embodiment of the invention, a fluoropolymer material is used for lens 20, rather than polycarbonate, polysulfone, epoxy, or other conventional lens materials. Lens 20 may be entirely fluoropolymer or may contain fluoropolymer and other materials. Examples of suitable fluoropolymer materials include (perfluoroalkoxy) fluoropolymer resin and fluorinated ethylene propylene, a copolymer of hexafluoropropylene and tetrafluoroethylene. Suitable materials are sold by E. I. du Pont de Nemours and Company as Teflon® PFA and Teflon® FEP. Fluoropolymer lenses exposed to 600 mW of 445 nm light at 85° C. and 60% humidity demonstrated no evidence of changes in clarity at 500 hours, a time when conventional lenses already showed distinct damage at less intensive exposure. Fluoropolymer lenses exposed to 75 mW of light demonstrated no evidence of changes in clarity at 1500 hours.

Fluoropolymer materials have several disadvantages when used as lenses for light emitting device packages. First, many fluoropolymers have a crystalline nature which makes them translucent, but not particularly clear. Reduced clarity in a lens is not desirable since it can cause light to scatter within the package, rather than exiting the package, thereby decreasing the overall efficiency of the packaged device. Second, fluoropolymers have a low index of refraction, which reduces refraction at the surface of the lens, reducing the ability to redirect the light to a particular target. The low index of refraction of fluoropolymers complicates the design of lens 20. Third, fluoropolymer resins are 5 to 25 times more expensive than the raw materials used to form conventional materials such as polycarbonate and epoxy. Fourth, fluoropolymers are difficult and expensive to mold into lenses. Noncorrosive molding materials must be used and steps must be taken to protect molding workers from corrosive outgassing. Fifth, fluoropolymers are difficult to adhere to. If the encapsulant between the chip and the lens does not adhere to the lens, a layer of air separates the encapsulant and the lens. The layer of air may cause internal reflection or otherwise disadvantageously interfere with the escape of light from the package. As a result, to provide proper adherence, fluoropolymer lenses must be quickly and carefully assembled into packages, increasing the cost of assembly. But for the degradation of conventional materials and the stability of fluoropolymers, fluoropolymers would be unsuitable for use as lenses for light emitting device packages.

Light emitting devices according to embodiments of the present invention may have several applications, including, for example, as a device for curing dental adhesives, or in combination with other light emitting devices in a display.

In one embodiment, light emitting devices including fluoropolymer lenses are included in applications which require uniform illumination of a flat panel that has an area larger than the area of the light emitting device chip. To provide uniform illumination of the entire flat panel in such applications, a large portion of the light generated by the light emitting device chip must exit lens 20 at nonzero angles to an axis perpendicular to the plane of the active region of the light emitting device chip, since light emitting at nonzero angles to the must travel further to intercept the panel than light emitting on-axis. One example of such an application is a traffic light. In the example of a traffic light, lens 20 may be designed such that the maximum intensity is emitted at angles between about 35° and about 45° off the perpendicular axis. The intensity on-axis may be about 35% to about 75% of the peak intensity. At angles greater than about 60°, the intensity may be less than 10% of the peak intensity. The location of the maximum in intensity, the amount of intensity on-axis, and other characteristics of the radiation pattern change depending on the size and shape of the panel to be illuminated.

Having described the invention in detail, those skilled in the art will appreciate that, given the present disclosure, modifications may be made to the invention without departing from the spirit of the inventive concept described herein. Therefore, it is not intended that the scope of the invention be limited to the specific embodiments illustrated and described.

What is being claimed is:

1. A light emitting device comprising:
a lens comprising a fluoropolymer; and
a semiconductor light emitting device chip underlying the lens.

2. The light emitting device of claim 1 wherein the semiconductor light emitting device chip is capable of emitting light having a peak wavelength ranging from green through near ultraviolet.

3. The light emitting device of claim 1 wherein the semiconductor light emitting device chip is capable of emitting light having a peak wavelength ranging from about 570 nm to about 360 nm.

4. The light emitting device of claim 1 wherein the fluoropolymer lens comprises (perfluoroalkoxy) fluoropolymer resin.

5. The light emitting device of claim 1 wherein the fluoropolymer lens comprises fluorinated ethylene propylene, a copolymer of hexafluoropropylene and tetrafluoroethylene.

6. The light emitting device of claim 1 wherein a clarity of the fluoropolymer lens is essentially unchanged after 500 hours of exposure to 600 mW of light having a peak wavelength ranging from green through blue.

7. The light emitting device of claim 6 wherein exposure comprises exposure at a temperature greater than or equal to about 85° C. and a relative humidity greater than or equal to about 60%.

8. The light emitting device of claim 1 wherein an outside shape of the fluoropolymer lens comprises a dome.

9. The light emitting device of claim 1 wherein a clarity of the fluoropolymer lens is essentially unchanged after 1500 hours of exposure to 75 mW of light having a peak wavelength ranging from green through blue.

10. The light emitting device of claim 1 wherein the semiconductor light emitting device chip comprises a plurality of semiconductor layers having the formula AlₓIn_{y}Ga_{z}N, where 0≦x≦1, 0≦y≦1, 0≦z≦1, x+y+z=1.

11. The light emitting device of claim 1 further comprising a lead frame connected to the semiconductor light emitting device chip.

12. The light emitting device of claim 11 further comprising a submount between at least a portion of the lead frame and at least a portion of the semiconductor light emitting device chip.

13. The light emitting device of claim 12 further comprising a heat sinking slug connected to the submount.

14. The light emitting device of claim 13 wherein the heat sinking slug comprises a reflector cup.

15. The light emitting device of claim 1 wherein the lens consists totally of a fluoropolymer.

16. The light emitting device of claim 1 wherein the lens is shaped such that a maximum intensity is emitted substantially along an axis perpendicular to the semiconductor light emitting device chip.

17. The light emitting device of claim 1 wherein the lens is shaped such that a maximum in intensity is emitted at angles between about 35° and about 45° from an axis perpendicular to the semiconductor light emitting device chip.

18. The light emitting device of claim 1 wherein the lens is shaped such that emission along an axis perpendicular to the semiconductor light emitting device chip is between about 35% and about 75% of a maximum intensity.

19. The light emitting device of claim 1 wherein the lens is shaped such that an intensity of emission at angles greater than about 60° to an axis perpendicular to the semiconductor light emitting device chip is less than about 10% of a maximum intensity.

20. The light emitting device of claim 1 wherein the semiconductor light emitting device chip is capable of emitting light having a peak wavelength suitable for curing dental adhesives.

21. The light emitting device of claim 1 further comprising a wavelength converting material capable of absorbing first light emitted from the semiconductor light emitting device chip and emitting second light having a wavelength longer than a wavelength of the first light.

22. The light emitting device of claim 21 wherein when the first light and second light are combined, the combined light appears white.

23. The light emitting device of claim 21 wherein the second light appears green.

24. The light emitting device of claim 1 wherein the semiconductor light emitting device chip is capable of emitting light having a peak wavelength ranging from about 360 nm to about 200 nm.

25. The light emitting device of claim 24 wherein the semiconductor light emitting device chip is capable of emitting light having a peak wavelength of about 280 nm.
